(19) United States
(12) Patent Application Publication
(10) Pub. No.: US 2012/0171335 A1
(43) Pub. Date: Jul. 5, 2012

(54) MULTI-LAYERED LOLLIPOP AND A METHOD OF MAKING THE SAME

(76) Inventors: Jules R. SHECTER, Boca Raton, FL (US); Lowell Fugal, Meridan, ID (US)

(21) Appl. No.: 12/982,385

(22) Filed: Dec. 30, 2010

(51) Int. Cl. A23G 3/54; A23G 3/56

(52) U.S. Cl. 426/91; 426/293

(57) ABSTRACT

A four-layered lollipop is provided for with a first innermost layer of a taffy product on an elongate, essentially rectilinear lollipop stick having a wide surface areas and thin sides. A second layer of hard candy completely covers the first or innermost layer, and a candy third layer is embedded in and covers only individual portions of said second layer. A fourth layer of candy is comprised of sugar particles that covers the surface of the existing candy. The lollipop stick has a plurality of ridges on both faces on the top portion which provide an attachment mechanism for retaining the taffy innermost layer adheres and providing the taffy product with a better surface to adhere to on the lollipop stick.

### BACKGROUND OF THE INVENTION

1. Technical Field of the Invention

The present invention relates generally to lollipops of the type of confections on a stick. More particularly the present invention relates to a multilayer lollipop, and the process of making the same.

2. Background of the Disclosure

The lollipop has been a popular form of confection for many years. Variations of the basic lollipop have appeared from time to time. Many different flavors of lollipops have been made from various types of confection compositions, but through vary few different processes. Usually these processes include putting a stick in a mold, pouring in a molten confection, and allowing the mold and product in it to cool to room temperature. Lollipops have traditionally included a hard candy in their composition, and in many cases, lollipops are made entirely of hard candy and a thin lollipop stick embedded in the candy. Other types of lollipops have two layers, such as an inner layer or center layer of a gum or of a TOOTSIE ROLL and an outer single layer of hard candy. Lollipops with more than two layers are not known.

One reason that conventional lollipops have no more than two layers is that it is difficult to have the outer layers adhere to the inner layers and to have the innermost layer adhere to the lollipop stick because there are no features on the stick to facilitate the adherence of the candy to the stick. Further, the process by which lollipops are made has dictated that a hard candy layer traditionally be used as a mold by which another layer would be injected, for example. This is the case with the TOOTSIE ROLL pop or BLOW POP, which comprise a layer of chewing gun or a layer of TOOTSIE ROLL enclosed in a layer of hard candy.

A lollipop is a confection or composition on a stick, and it has long been a difficulty of lollipop manufacturers to create novel processes to adhere different confectionery products to the lollipop stick. As such, the need and desire to adhere different confectionery products to each other has long been desired.

Hard candy has traditionally been applied to a lollipop stick through two distinct processes. The first process entails inserting a stick into a mold and then depositing a liquid molten solution of a hard candy directly into a mold where the liquid molten solution is then cooled. The second process for making lollipops entails cooking and partially cooling a liquid molten solution of hard candy before forming the lollipop into shapes and inserting the stick. Both of these processes can be performed manually or by a machine.

Further, many different shapes and sizes of lollipops have been made. Most often, the shape of lollipops has been relatively simple, e.g. a flat disc, sphere, oval, or a figure. Some lollipops have been formed into more complex shapes by pouring the molten candy into a mold which forms a front side of the lollipop into a desired shape, such as a face, leaving the back of the lollipop flat.

Lollipop sticks are traditionally cylindrical with a small exterior surface area on which candy can adhere.

There are no known lollipops in existence today which are comprised of four layers of candy, or which includes a first or innermost layer of taffy. Further, there is no process for producing multi-layered lollipop products which facilitate the adherence of a semi-solid candy directly to a lollipop stick, without either placing the semi-solid substance in an already existing hard candy mold or without partially cooking the hard candy simultaneously around the semi-solid layer.

### SUMMARY OF THE INVENTION

It is an object of the present invention to provide a multilayer lollipop having for example four layers of candy, including a first or innermost layer of a taffy product that directly contacts applied directly to a lollipop stick before the introduction of any other layer of candy.

It is a further object of the present invention to provide an improved process for making a multilayer lollipop of candy, including a first layer of a taffy product applied directly to a lollipop stick, or in a presently preferred embodiment cut to an appropriate length and wound or wrapped around a lollipop stick.

The process and lollipop disclosed herein provide a unique way of adhering many different layers of candy together on a central stick and the product produced thereby. In a preferred embodiment, the lollipop includes a first or innermost layer of a taffy product directly to a lollipop stick having a wider surface area than is common.

Further, the present invention provides a unique manner by which hard candy can be applied to a lollipop. The result of the process is a lollipop product having four layers of candy, including a first layer of a taffy product that is applied prior to the introduction of any hard candy directly to the lollipop stick.

In accordance with a preferred embodiment of the present invention an improved lollipop is comprised of a multilayer body and an embedded stick. In this preferred embodiment the lollipop stick has an elongate shape with a wide front and back and relatively thin sides. The lollipop stick further comprises at least one arcuate or curved, raised ridge on a top front portion of the stick for retaining a taffy product that is the innermost layer. A bottom end of the lollipop stick is a handle by which the lollipop may be held by a user. The lollipop body includes a first layer of a taffy product encircling the stick, which layer can be wound or wrapped around the top portion of the lollipop stick; a second layer of hardened candy enveloping the first layer of candy; and a third layer of candy on at least a portion of the second layer so as to leave exposed portions of the second layer. A fourth layer of a flavored particle coating is located on top of the third layer and any exposed portions of the second layer. In one embodiment of the present invention, the first, second, third, and fourth layers of candy comprise different flavors.

In another preferred embodiment of the invention, the first or innermost layer is a taffy that can be up to a quarter inch thick, and that is comprised of one or more strips of taffy. In a particular embodiment of the invention in order to increase the adherence of the taffy layer to a lollipop stick that has relatively wide front and back or rear sides, the stick has a plurality of arcuate, parallel ribs perpendicularly extending from the surfaces of the front and rear sides of the stick.

In an even more preferred embodiment of the present invention there is a lollipop stick which can be made of wood, polyvinyl chloride (PVC) or other plastic or any combination thereof. Such a stick has front and rear sides with a width that is at least one-eighth of the length of the stick.

### BRIEF DESCRIPTION OF THE DRAWINGS

In the drawings:

FIG. 1 is a perspective view of a preferred embodiment of a lollipop of the present invention.

FIG. 2 is a front elevational view of the embodiment of a lollipop as shown in FIG. 1.

FIG. 3 is a cross-sectional view taken along line 3-3 of FIG. 2.

FIG. 4 is a top plan view of the lollipop as shown in FIG. 1.

FIG. 5 is a side elevational view of the lollipop as shown in FIG. 1, the other side being substantially the same.

FIG. 6 is a bottom plan view of the lollipop as shown in FIG. 1.

FIG. 7 is a front elevational view of one embodiment of a lollipop stick of the present invention.

FIG. 8 is a side elevational view of the lollipop stick as shown in FIG. 7.

### DETAILED DESCRIPTION OF THE PRESENTLY PREFERRED EMBODIMENT OF THE INVENTION

This invention will now be described in detail with reference to the accompanying drawings, which represent by example a preferred embodiment of the present invention. Structural details are shown only as far as necessary for a fundamental understanding thereof. The described examples, together with the drawings, will make apparent to those skilled in the art how further forms of the invention may be realized.

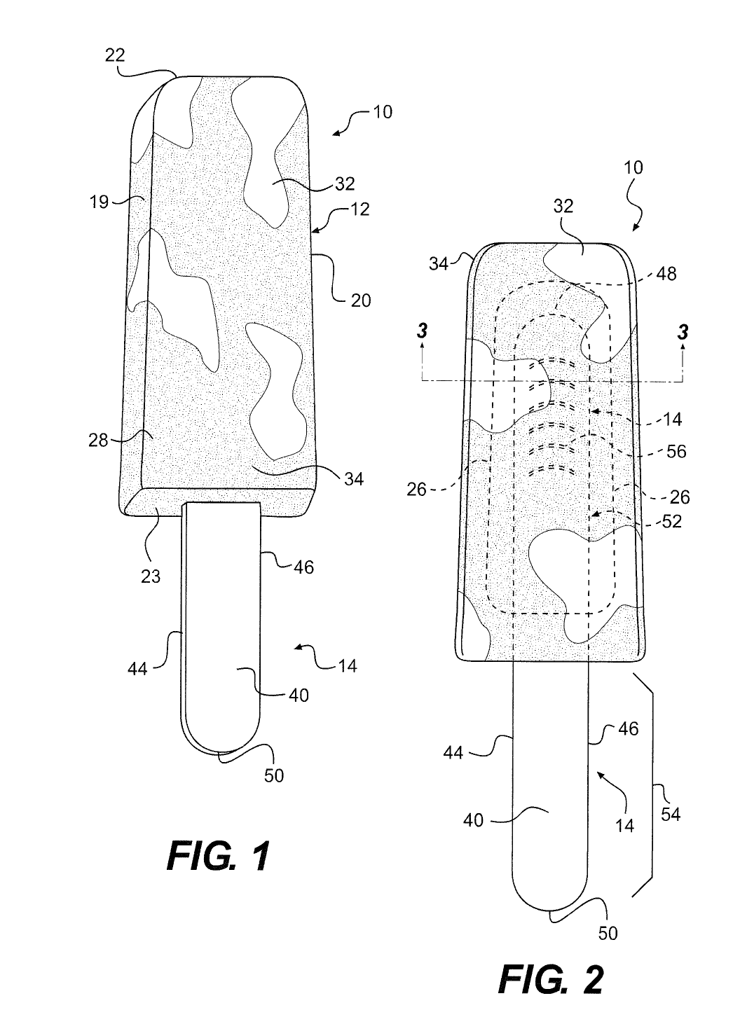

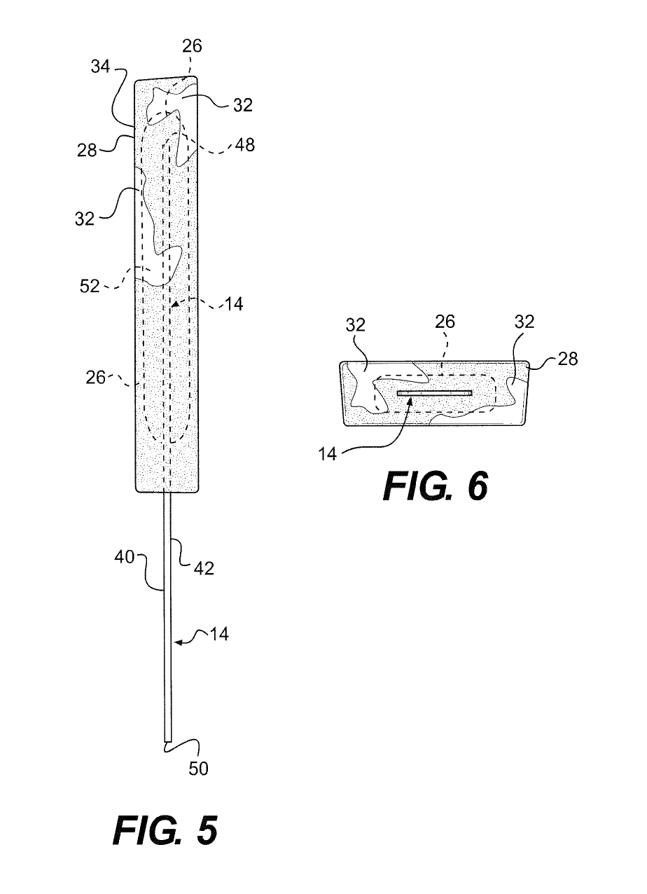

In the drawings, like numbers refer to like elements throughout the several views, and in particular with reference to FIGS. 1-6, one embodiment of a lollipop 10 according to the present invention is depicted. Lollipop 10 is comprised of a body portion 12 and a lollipop stick 14 and is depicted in FIGS. 1 and 2 in an upright position.

Body portion 12 is comprised of a left side 19 and a right side 20 that is substantially the same as left side 19, a top 22, and a bottom 23. Body portion 12 has a trapezoidal shape with the width of top 22 being shorter than the width of bottom 23. Further, left side 19 and right side 20 also have a trapezoidal shape with top 22 having a shorter depth than the depth of bottom 23.

Lollipop 10 has the following exemplary dimensions. Body portion 12 is 33 mm in width across top 22, 37 mm in width across bottom 23, 78 mm in length along both left side 19 and right side 20 from top 22 to bottom 23. From bottom 23 to the end lower portion of stick 14 the distance is 55 mm in length.

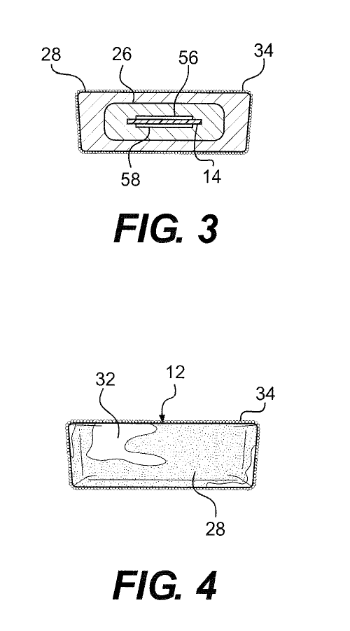

Body portion 12 is comprised of four (4) layers as particularly shown in FIG. 3. An innermost or first layer 26 of a candy comprises a taffy product that envelopes or encircles and is attached to lollipop stick 14. A second layer 28 of candy fully coats first layer 26 on all sides. A third layer 32 of candy partially is embedded in said second layer 28 as a plurality of asymmetrically, irregularly shaped patches or blotches, as shown in FIG. 1. Second and third layers 28 and 32 form a smooth surface of body portion 12.

In this particular embodiment, second layer 28 forms a majority of the surface area of body portion 12. Finally, a fourth and outermost layer 34 covers those exposed portions of second layer 28 and third layer 32 that can be seen outside of body portion 12. Fourth layer 34 is a particle coating that completely covers the entire body portion 12 is depicted only in FIGS. 3 and 4, as small circles or dots on the surface of the exposed portions on second and third layers of candy 28 and 32.

First or innermost layer 26 is approximately one-quarter inch thick, but could be much thinner or could be as much as a half inch thick, or even thicker. Second layer 28 is made of a candy with a first sour flavor and third layer 32 is made of a candy of a second sour flavor. Fourth layer 34 is preferable made of sweet or sugary small particles.

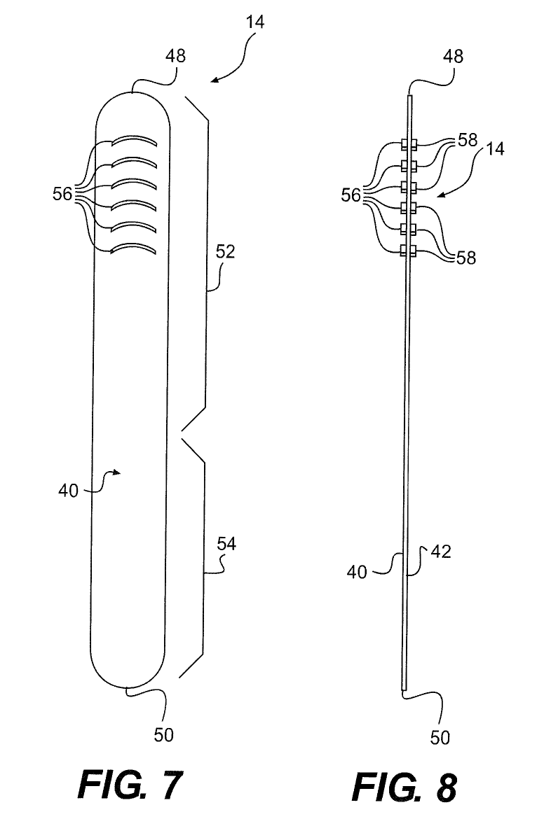

Lollipop stick 14, as seen in FIGS. 7 and 8, is symmetrical and has an elongate rectilinear shape with a front side 40 and a rear side 42, which are substantially flat and relatively wide, and thinner, with respect to left and right sides 44 and 46. Lollipop stick 14 has a rounded top 48 and a rounded bottom 50. Stick 14 is divided into a first or top end portion 52 and a second or bottom end portion 54 that is the handle of lollipop 10.

In a presently preferred embodiment, lollipop stick 14 has an overall exemplary length of about 100 mm and an overall exemplary width of about 15 mm. Thus the width of front and rear sides 40 and 42 is about one-sixth the length of stick 14. Top end portion 52 is the candy retention part of stick 14, is completely embedded or enclosed in body portion 12 (as shown in FIG. 2) and has an exemplary length of about 50 mm. An exemplary dimension of top end portion 52 is 50 mm. Obviously, the components of lollipop stick can have other dimensions. Thus, depending upon the length of lollipop body portion 12, the length and width of stick 14 can vary proportionately.

Lollipop stick 14 has a plurality of arcuate ridges, 56 and 58, thereon on the upper part of top end portion 52 on front side 40 and on rear side 42, respectively. In the embodiment depicted in the drawings there are six parallel arcuate ridges 56 and 58 and the ridges on front side 40 are aligned with the ridges on rear side 42. Ridges 56 and 58 are substantially the same except for their location and each protrudes or extends outwardly on front side 40 and rear side 42, respectively, of stick 14, to a height of about 1 mm Ridges 56 and 58 help retain first candy layer 26 on stick 14.

Lollipop stick 14 can be made of a plastic material, such as a PVC, of wood, or a like material. Second end portion 50 has a shape and width that is the same as first end portion 52 except that second end portion 50 does not have any arcuate ridges on it. Second end portion 50 is the handle of lollipop 10.

A preferred method of making lollipop 12 is as follows.

Step (a): wrapping a single strip of a taffy product that is approximately quarter-inch thick, about 55 mm long and about as the first or innermost layer around a first end portion of a lollipop stick to form the innermost part of the body of the lollipop;

Step (b): curing the taffy for about at least 8 hours at 150 degrees C.;

Step (c): cooling the taffy to 100 degrees C.;

Step (d): dipping the taffy body into a hot molten candy having a temperature of approximately 260 degrees C. to 280 degrees C. for approximately 1 to 2 seconds to form a second layer;

Step (e): allowing the candy to cool;

Step (f): pouring hot liquid candy onto at least a portion of the second layer of hardened candy so as to be embedded therein and to form a third layer;

Step (g): inserting the lollipop body into a metal or silicon mold and allowing the lollipop to cool and harden;

Step (h): removing the lollipop body from the mold;

Step (i): applying steam to the lollipop body; and

Step (j): sprinkling candy particles on the outside of the lollipop body to form a fourth layer.

Further benefits, features and details of the invention will become apparent or be obvious from a review of the following description, when taken in view of the accompanying drawings and appended claims.

What is claimed is:

1. A lollipop comprising:
a body portion having at least three layers of a confection; and
an elongate lollipop stick having front and rear sides, an upper portion and a lower portion, the upper portion having at least one curved ridge extending outwardly from at least one of the front and rear sides of said lollipop stick in said upper portion thereof, said upper lollipop stick portion, extending completely inside said body portion, and said lower portion defining a handle.

2. The lollipop as claimed in claim 1 wherein said body portion is comprised of four confection layers.

3. The lollipop as claimed in claim 2 wherein said body portion is comprised of
a first layer of a taffy candy extending around at least a portion of said upper portion of said lollipop stick,
a second layer of hardened candy enveloping said first layer of candy;
a third layer of candy at least partially covering said second layer and leaving exposed portions of the second layer; and
a fourth layer comprised of a particle coating on top of the third layer and the exposed portions of the second layer.

4. The lollipop as claimed in claim 3 wherein said third layer is embedded in said second layer such that an overall surface of said lollipop is substantially smooth.

5. A lollipop as claimed in claim 4, wherein said first layer of said taffy product is approximately one-quarter inch thick.

6. A lollipop as claimed in claim 3, wherein said first layer is a taffy candy, and said second layer, and said third layer are of a different flavor of candy.

7. A lollipop as claimed in claim 1, wherein the front and rear sides of said body portion are substantially flat and have a trapezoidal shape in elevational view.

8. The lollipop as claimed in claim 1, wherein said lollipop stick is made of a plastic material or of wood.

9. The lollipop as claimed in claim 1, wherein the width of said front and rear sides of said stick are approximately one-sixth as wide as they are long.

10. A lollipop as claimed in claim 9, wherein the upper portion of said stick has at least three arcuate ridges on each of the front and rear sides, said arcuate ridges are parallel to one another, and said ridges on said front side of said stick are aligned.

11. A process for making lollipops comprising:
(a) providing a lollipop stick;
(b) wrapping a taffy product around a top end portion of said lollipop stick;
(c) curing the taffy product;
(d) cooling the cured taffy product;
(e) dipping the top end portion of the taffy product covered stick into hot molten candy to form a second layer and allowing the candy to cool and harden;
(f) pouring hot liquid candy onto portions of the hardened hot candy;
(g) inserting the candy into a mold and allowing it to cool and harden;
(h) removing the hardened candy from the mold;
(i) applying steam to the hardened candy that has been removed from the mold; and
(j) sprinkling a plurality of sugar particles all over the hardened candy.

12. A process for making lollipops as claimed in claim 11 wherein said taffy is cured for at least 8 hours at about 150 degrees C., and then is cooled to about 100 degrees C.

13. A process for making lollipops as claimed in claim 12 wherein the temperature of the molten candy is approximately 260 degrees C. to 280 degrees C. for approximately 1 to 2 seconds to form a second layer and allowing the candy to cool and harden.

14. A process for making lollipops as claimed in claim 11 wherein the temperature of the molten candy is approximately 260 degrees C. to 280 degrees C. for approximately 1 to 2 seconds to form a second layer and allowing the candy to cool and harden.

15. A lollipop comprising:
an elongate lollipop stick having front and rear sides; and having an upper portion and a bottom portion; and
a body portion comprised of:
a first layer of a candy fixedly mounted on said upper portion of said lollipop stick, said first layer comprising a strip of a taffy product;
a second layer of hardened candy enveloping said first layer of candy;
a third layer of candy on at least a portion of said second layer, thereby leaving an exposed portion of said second layer; and
a fourth layer on top of the third layer and exposed second layer, said fourth layer comprising a particle coating.

16. A lollipop as claimed in claim 15, wherein said lollipop stick has an overall rectangular shape, and the top portion having at least one upstanding curved ridge.

17. A lollipop as claimed in claim 16, wherein said stick has a wide surface area on the front and rear sides, the bottom portion defining a handle A lollipop as claimed in claim 15, wherein the front and rear sides of said body portion are basically flat.

18. A lollipop as claimed in claim 16, wherein the first layer, second layer, and third layers comprise at least one flavor of candy, and wherein said first layer of said taffy product is approximately one-quarter inch thick.

19. A lollipop as claimed in claim 16, wherein the lollipop stick is made of poly vinyl chloride (PVC) and the front and rear sides of said stick are approximately one-sixth as wide as the length of said stick.

20. A lollipop as claimed in claim 19, wherein the top portion of said stick has a at least three arcuate ridges aligned in parallel in a column on each of the front and rear sides of the stick, and an arcuate ridge on one side of said stick is horizontally and vertically aligned with a corresponding arcuate ridge on the other side of said stick.
